(19) United States
(12) Patent Application Publication
(10) Pub. No.: US 2023/0266903 A1
(43) Pub. Date: Aug. 24, 2023

(54) QUAD-LEVEL CELLS MAPPED IN A MEMORY DEVICE OF AN INFORMATION HANDLING SYSTEM

(71) Applicant: Dell Products L.P., Round Rock, TX (US)

(72) Inventors: Ghim Teck Toh, Singapore (SG); Wenhua Li, Singapore (SG); Vinoth John Paul Nedunchezhian, Singapore (SG)

(21) Appl. No.: 17/678,424

(22) Filed: Feb. 23, 2022

(51) Int. Cl. G06F 3/06

(52) U.S. Cl. CPC G06F 3/0644; G06F 3/0659; G06F 3/0613; G06F 3/0679

(57) ABSTRACT

An information handling system includes a host processor, and a memory device. The memory device communicates with the host processor. The memory device includes an operating system mapping storage memory partition, which in turn includes first, second and third, memory portions. The first memory portion includes single-level cells, and the first portion of memory is a static portion of memory, a dynamic portion of memory, or a mixed static and dynamic portion of memory. The second memory portion includes triple-level cells, and the second portion of memory is a static portion of memory. The third memory portion includes quad-level cells.

### FIELD OF THE DISCLOSURE

The present disclosure generally relates to information handling systems, and more particularly relates to quad-level cells mapped in a memory device of an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a host processor, and a memory device. The memory device communicates with the host processor. The memory device includes an operating system mapping storage memory partition, which in turn includes first, second and third memory portions. The first memory portion includes single-level cells, and the first portion of memory may be static portion of memory, mixture of static and dynamic portion of memory, or dynamic portion of memory. The second memory portion includes triple-level cells, and the second portion of memory is a static portion of memory. The third memory portion includes quad-level cells.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a perspective view of an information handling system according to at least one embodiment of the disclosure;

FIG. 2 is a block diagram of a portion of an information handling system according to at least one embodiment of the present disclosure;

FIG. 3 is a block diagram of a memory device of an information handling system according to at least one embodiment of the present disclosure;

FIG. 4 is a flow diagram of a method for utilizing a memory device including multiple portions having different level cells according to at least one embodiment of the present disclosure; and

FIG. 5 is a block diagram of an information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

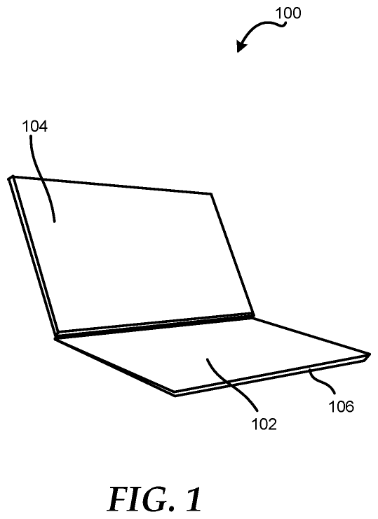

FIG. 1 illustrates an information handling system 100 according to at least one embodiment of the disclosure. For purpose of this disclosure information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch, a router, or another network communication device, or any other suitable device and may vary in size, shape, performance, functionality, and price.

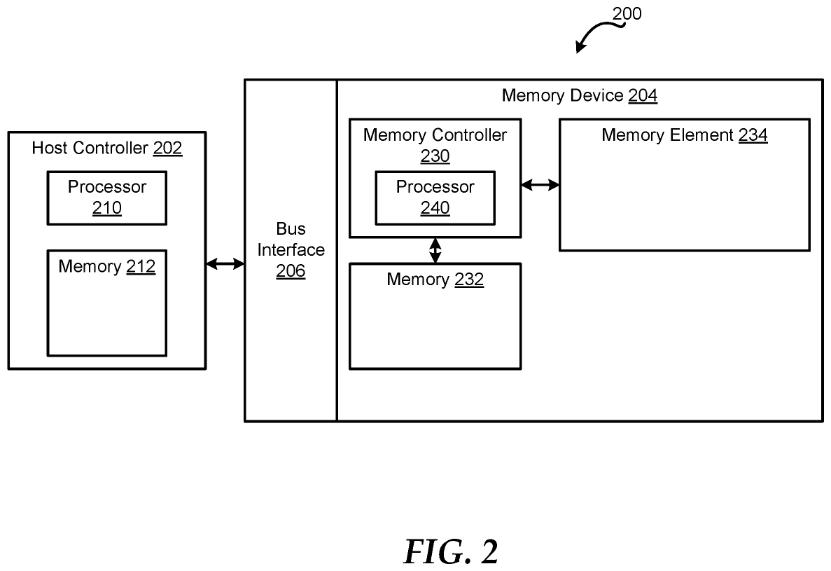

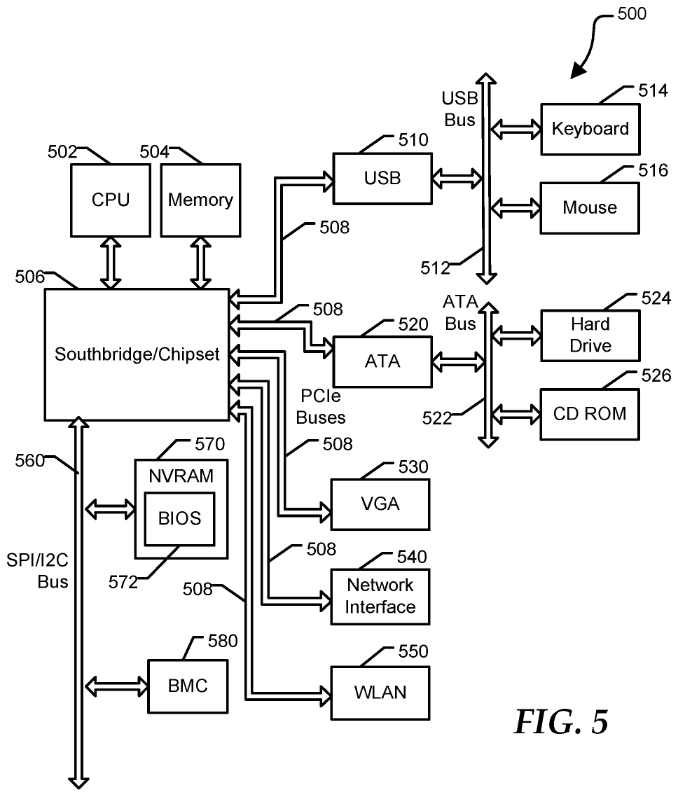

Information handling system 100 includes a base 102 and a display device 104. Base 102 includes a cover 106, which in turn may surround one or more components of information handling system 100. In an example, the components of information handling system 100 may be any suitable components, such as the components described for information handling system 200 in FIG. 2, information handling system 500 in FIG. 5, or the like.

During operation, information handling system 100 may store data in a memory device, such as memory device 204 of FIG. 2. In an example, the memory device may be any suitable type of memory device including, but not limited to, a non-volatile memory express solid state device (NVMe SSD). In certain examples, the memory device may include multiple memory partitions with different levels of cells. For example, the different levels of cells may include, but are not limited to, single-level cells (SLC), triple-level cells (TLC), and quad-level cells (QLC). In an example, the different levels of cells may have different performance characteristics. In certain examples, writing data from a SLC memory partition to a QLC memory partition may experience a large performance drop and lower endurance of the memory cells as compared to writing the data to a TLC memory partition. For example, frequently accessing data in the QLC memory partition may cause the QLCs to wear out faster than frequently accessing data in the TLC memory partition.

FIG. 2 illustrates a portion of an information handling system 200 according to at least one embodiment of the present disclosure. In an example, information handling system 200 may be substantially similar to information handling system 100 of FIG. 1. Information handling system 200 includes a host controller 202, a memory device 204, and a bus interface 206. Host controller 202 includes a processor 210 and a memory 212, which in turn may store any suitable data. Memory device 204 includes a memory controller 230, a memory 232, and a memory element 234. While memory 232 is illustrated as being external of memory controller 230, memory 232 may be internal to memory controller 230 without varying from the scope of this disclosure. Memory controller 230 includes a processor 240. Memory element 234 may be any suitable array, such as a non-volatile memory array. Memory element 234 may be comprised of one or more separate memory partitions that may be flash memory or any other solid-state memory. In certain examples, the individual memory partitions may be NAND flash memory partitions with SLC, TLC, or QLC.

In an example, memory controller 230 may utilize any suitable communication channel, by which the memory controller may receive certain commands from host controller 202, such as read and write commands. For example, memory device 204 may be connected to host controller 202 according to various embodiments. This connection between memory device 204 and host controller 202 may utilize bus interface 206. Bus interface 206 may be any physical connection capable of supporting a peripheral component interconnect express (PCIe) bus interface connection between host controller 202 and memory device 204. In certain examples, processors 210 and 240 may be any suitable processing devices, such as microprocessors, microcontrollers, application-specific integrated circuits (ASICs), field-programmable gate arrays (FPGAs), or the like. In any example, memories 212 and 232 may be referred to as DRAM memories or volatile memories.

Processor 240 of memory controller 230 may be used to execute software code, in particular firmware and/or machine software code that implements the read and write operations supported by the memory controller. These supported read and write operations may be used to access memory element 234 that provides the main storage of memory device 204 that is typically available to the operating system of host controller 202.

In an example, SSD has become the main storage device for information handling systems, such as information handling system 200. SSD may be utilized as memory device 204 based on SSD may be more energy efficient, quiet, higher performance and low latency as compared to rotational media storage devices. As a demand for increased storage capacity of SSD grows, the cost per Gigabyte of storage may be maintain or be lower to supply the need for SSDs in the market and to replace the traditional rotational media storage device.

In previous information handling systems, the storage devices may include denser memory cells to bring the cost per Gigabyte down. For example, previous storage device may include single-level cell (SLC) NAND flash memory, multi-level cell (MLC) NAND flash memory, triple-level cell (TLC) NAND flash memory, and quad-level cell (QLC) NAND flash memory. The storage capacity in each cell of QLC NAND may be substantially greater than the storage capacity in each cell of TLC, such as thirty-three percent more data may be stored in each cell. SLC NAND flash memory includes one bit per cell, MLC NAND flash memory includes two bits per cell, TLC NAND flash memory includes three bit per cell, and QLC NAND flash memory includes four bits per cell. However, as the number of bits increase in each cell, there are impact on the performance and reliability in the memory device. For example, as the number of bits increase, writing data to a cell may be slower and the cells may wear out faster as compared to cells with fewer bits.

In an example, NAND memory cells have a finite number of program-erase (P/E) cycles and higher density cells may have less endurance as compared to low density cells. This lower endurance may be based on the higher density cells need to program or erase more bits per cell as compared to a lower density cell each time a write operation is performed. Therefore, the endurance of a QLC NAND is less than a TLC NAND, the endurance of a TLC NAND is less than a MLC NAND, and the endurance of a MLC NAND is less than a SLC NAND. In an example, a QLC NAND may only have seventy-five percent of the endurance of a TLC NAND.

Additionally, performance of a NAND flash memory device may also be impacted as the number of bits per cell increases. This performance impact or performance drop is based on the increase in the number of cells to be programed and erased within the cell when a write operation is performed. In an example, read operations of a QLC NAND may be twice as long as read operations of a TLC NAND, and write operations of the QLC NAND may be three and a half times longer than write operations of the TLC NAND.

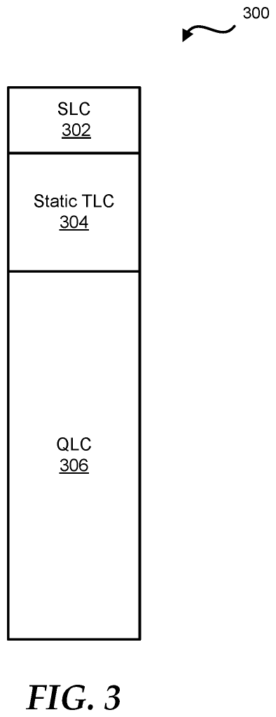

FIG. 3 illustrates a memory device 300 of an information handling system according to at least one embodiment of the present disclosure. Memory device 300 may be substantially similar to memory element 234 of FIG. 2. Memory device 300 may be any suitable type of memory device, such as a NAND flash memory of a SSD. Memory device 300 includes memory partitions 302, 304 and 306. Memory partition 302 includes SLC NAND memory, memory partition 304 includes TLC NAND memory, and memory partition 306 includes QLC NAND memory. In an example, memory partition 302 may be a static memory partition, a dynamic memory partition, or a mixed memory partition of static and dynamic memory. Memory partition 304 may be a static memory partition. The size of memory partitions 302 may be fixed, may vary, or may include a portions that is fixed and portion that may vary. The size of memory partition 304 may be fixed, such that the size does not vary. In an example, if memory partition 304 is dynamic or a mixture of static and dynamic, the size of memory partition 302 may vary based on usage of memory device 300. In certain examples, if memory partition 302 needs additional storage capacity, the additional storage capacity may be reallocated from memory partition 306 to memory partition 302.

In an example, an OS for an information handling system, such as information handling system 200 of FIG. 2, may be stored within memory partition 304. In certain examples, the OS may be stored within the first forty GigaBytes of logical block addressing (LBA) of a memory device, such as memory device 300. This range of LBA may be most frequently used by a host processor of an information handling system, such as host processor 210 of information handling system 200 in FIG. 2. Memory partition 304 may be assigned the first forty GigaBytes of the LBA, such as LBA 0 through LBA 78,125,000, in memory device 300. In certain examples, the amount of storage capacity in memory device 300 assigned to the OS may vary according to different OS application sizes. In these examples, if an information handling system includes an OS application larger than forty GigaBytes, memory partition 304 may be assigned more than the first forty GigaBytes, such as a storage size substantially equal to the size of the OS application.

As stated above, QLC NAND may have a large performance drop and lower endurance as comparted to TLC NAND. Based on this difference between QLC NAND and TLC NAND, the data most frequently accessed by a host processor, such as host processor 210, may be stored within memory partition 304 to improve the performance and endurance of memory device 300.

During operation of an information handling system, such as information handling system 200, the host processor may frequently access data associated with files and folders of the OS and this data may be written from memory partition 302 to memory partition 304 during this operations. In an example, writing data from memory partition 302 with SLC NAND to memory partition 304 with TLC NAND may be substantially faster than writing data from memory partition 302 with SLC NAND to memory partition 306 with QLC NAND. Additionally, as stated above, the TLC NAND of memory partition 304 may have better endurance than the QLC NAND of memory partition 306. Based on the performance differences between memory partitions 304 and 306, the large data files that are frequently accessed may be stored in memory partition 304 while data that is less frequently accessed may be stored in memory partition 306.

In an example, memory device 300 may enable an information handling system, such as information handling system 200 of FIG. 2, to deliver a high capacity storage solution with memory partition 306 including QLC NAND and to provide high performance and high endurance by utilizing memory partition 304 with TLC NAND for storage of frequently access data. Additionally, if memory device 300 is near full capacity and memory partition 302 with SLC NAND is full, memory partition 304 with TLC NAND may be utilized to store frequently accessed data instead of storing this data in memory partition 306 with QLC NAND. As stated above, the used of TLC NAND, such as in memory partition 304, instead of QLC NAND, such as in memory partition 306, for frequently accessed data may provide a high performance of the memory device.

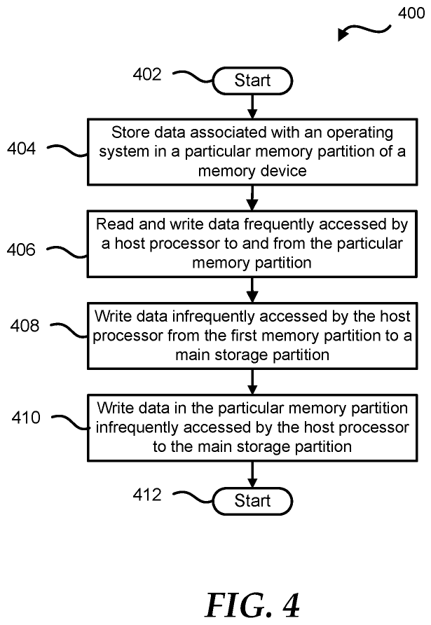

FIG. 4 is a flow diagram of a method for utilizing a memory device including multiple portions having different level cells according to at least one embodiment of the present disclosure, starting at block 402. It will be readily appreciated that not every method step set forth in this flow diagram is always necessary, and that certain steps of the methods may be combined, performed simultaneously, in a different order, or perhaps omitted, without varying from the scope of the disclosure. FIG. 4 may be employed in whole, or in part, processor 210 or processor 240 of FIG. 2, or any other type of controller, device, module, processor, or any combination thereof, operable to employ all, or portions of, the method of FIG. 4.

At block 404, data associated with an operating system (OS) of an information handling system is stored in a particular memory partition of a memory device in the information handling system. In an example, the OS may be executed by a host processor of the information handling system based on the data stored in a first memory partition of the memory device. In certain examples, memory device may include first, second and third memory partitions. In an example, the particular memory partition may be the second memory partition. The third memory partition may be referred to as the main storage for the information handling system. In an example, the first memory partition may be a static memory partition with single-level cells, a dynamic memory partition with single-level cells, or a mixed static and dynamic memory partition, the second memory partition may be a static memory partition with triple-level cells, and the third or main storage partition may include quad-level cells.

At block 406, data frequently accessed by the host processor may be written to and from the particular memory partition. In an example, data, such as files and folders for the OS, may be stored in the first forty GigaBytes of a logical block addressing range of the memory device. This data may be frequently accessed by the host processor while executing the OS. In an example, the first forty GigaBytes of a logical block addressing range of the memory device may be mapped to the particular memory partition of the memory device to increase performance of data accessed in the memory device as compared to data stored in the fourth memory partition.

At block 408, data infrequently access by the host processor may be written from the first memory partition to the third memory partition. In certain examples, writing data from the first memory partition to the third memory partition may experience a large performance drop and lower endurance of the memory cells in the third memory partition as compared to the second memory partition. For example, frequently accessing the quad-level cells in the third memory partition may cause the quad-level cells to wear out faster than frequently accessing the triple-level cells in the second memory partition.

At block 410, data in the particular memory partition that is no longer frequently accessed by the host processor is written to the third memory partition, and the method ends at block 412. In an example, data stored in the particular memory partition may no longer be frequently accessed by the host processor based on any suitable criteria. In certain examples, a determination of whether data is less frequently accessed may be made based on a number of accesses during a particular time window. Based on data no longer being frequently accessed, memory in the particular memory partition may be freed by writing the less frequently accessed data from the particular memory partition to the third memory partition.

FIG. 5 illustrates an information handling system 500 including a processor 502, a memory 504, a chipset 506, a PCI bus 508, a universal serial bus (USB) controller 510, a USB 512, a keyboard device controller 514, a mouse device controller 516, a configuration database 518, an ATA bus controller 520, an ATA bus 522, a hard drive device controller 524, a compact disk read only memory (CD ROM) device controller 526, a video graphics array (VGA) device controller 530, a network interface controller (NIC) 540, a wireless local area network (WLAN) controller 550, a serial peripheral interface (SPI) bus 560, a flash memory device 570 for storing BIOS code 572, a trusted platform module (TPM) 580, and a baseboard management controller (EC) 590. EC 590 can be referred to as a service processor, and embedded controller, and the like. Flash memory device 570 can be referred to as a SPI flash device, BIOS non-volatile random access memory (NVRAM), and the like. EC 590 is configured to provide out-of-band access to devices at information handling system 500. As used herein, out-of-band access herein refers to operations performed without support of CPU 502, such as prior to execution of BIOS code 572 by processor 502 to initialize operation of system 500. In an embodiment, system 500 can further include a platform security processor (PSP) 574 and/or a management engine (ME) 576. In particular, an x86 processor provided by AMD can include PSP 574, while ME 576 is typically associated with systems based on Intel x86 processors.

PSP 574 and ME 576 are processors that can operate independently of core processors at CPU 502, and that can execute firmware prior to the execution of the BIOS by a primary CPU core processor. PSP 574, included in recent AMD-based systems, is a microcontroller that includes dedicated read-only memory (ROM) and static random access memory (SRAM). PSP 574 is an isolated processor that runs independently from the main CPU processor cores. PSP 574 has access to firmware stored at flash memory device 570. During the earliest stages of initialization of system 500, PSP 574 is configured to authenticate the first block of BIOS code stored at flash memory device 570 before releasing the x86 processor from reset. Accordingly, PSP 574 provides a hardware root of trust for system 500. ME 576 provides similar functionality in Intel-based systems. In another embodiment, EC 590 can provide aspects of a hardware root of trust. The root of trust relates to software processes and/or hardware devices that ensure that firmware and other software necessary for operation of an information handling system is operating as expected.

Information handling system 500 can include additional components and additional busses, not shown for clarity. For example, system 500 can include multiple processor cores, audio devices, and the like. While a particular arrangement of bus technologies and interconnections is illustrated for the purpose of example, one of skill will appreciate that the techniques disclosed herein are applicable to other system architectures. System 500 can include multiple CPUs and redundant bus controllers. One ore more components can be integrated together. For example, portions of chipset 506 can be integrated within CPU 502. In an embodiment, chipset 506 can include a platform controller hub (PCH). System 500 can include additional buses and bus protocols, for example I2C and the like. Additional components of information handling system 500 can include one or more storage devices that can store machine-executable code, one or more communications ports for communicating with external devices, and various input and output (I/O) devices, such as a keyboard, a mouse, and a video display.

For purposes of this disclosure information handling system 500 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch, a router, or another network communication device, or any other suitable device and may vary in size, shape, performance, functionality, and price. Further, information handling system 500 can include processing resources for executing machine-executable code, such as CPU 502, a programmable logic array (PLA), an embedded device such as a System-on-a-Chip (SoC), or other control logic hardware. Information handling system 500 can also include one or more computer-readable medium for storing machine-executable code, such as software or data.

BIOS code 572 can be referred to as a firmware image, and the term BIOS is herein used interchangeably with the term firmware image, or simply firmware. In an embodiment, BIOS 572 can be substantially compliant with one or more revisions of the Unified Extensible Firmware Interface (UEFI) specification. As used herein, the term Extensible Firmware Interface (EFI) is used synonymously with the term UEFI. The UEFI standard replaces the antiquated personal computer BIOS system found in some older information handling systems. However, the term BIOS is often still used to refer to the system firmware. The UEFI specification provides standard interfaces and interoperability guidelines for devices that together make up an information handling system. In particular, the UEFI specification provides a standardized architecture and data structures to manage initialization and configuration of devices, booting of platform resources, and passing of control to the OS. The UEFI specification allows for the extension of platform firmware by loading UEFI driver and UEFI application images. For example, an original equipment manufacturer can include customized or proprietary images to provide enhanced control and management of the information handling system 500. While the techniques disclosed herein are described in the context of a UEFI compliant system, one of skill will appreciate that aspects of the disclosed systems and methods can be implemented at substantially any information handling system having configurable firmware.

BIOS code 572 includes instructions executable by CPU 502 to initialize and test the hardware components of system 500, and to load a boot loader or an operating system (OS) from a mass storage device. BIOS code 572 additionally provides an abstraction layer for the hardware, i.e. a consistent way for application programs and operating systems to interact with the keyboard, display, and other input/output devices. When power is first applied to information handling system 500, the system begins a sequence of initialization procedures. During the initialization sequence, also referred to as a boot sequence, components of system 500 are configured and enabled for operation, and device drivers can be installed. Device drivers provide an interface through which other components of the system 500 can communicate with a corresponding device.

The storage capacity of SPI flash device 570 is typically limited to 32 MB or 54 MB of data. However, original equipment manufacturers (OEMs) of information handling systems may desire to provide advanced firmware capabilities, resulting in a BIOS image that is too large to fit in SPI flash device 570. Information handling system can include other non-volatile flash memory devices, in addition to SPI flash device 570. For example, memory 504 can include non-volatile memory devices in addition to dynamic random access memory devices. Such memory is referred to herein as non-volatile dual in-line memory module (NVDIMM) devices. In addition, hard drive 524 can include non-volatile storage elements, referred to as a solid state drive (SSD). For still another example, information handling system 500 can include one or more non-volatile memory express (NVMe) devices. Techniques disclosed herein provide for storing a portion of a BIOS image at one or more non-volatile memory devices in addition to SPI flash device 570.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A memory device for an information handling system, the memory device comprising:
a plurality of memory partitions to store data associated with an operating system of the information handling system, the partitions including:
a first memory partition including single-level cells;
a second memory partition including triple-level cells; and
a third memory partition including quad-level cells.

2. The memory device of claim 1, wherein data of the operating system frequently accessed by a host processor of the information handling system is written from the first memory partition to the second memory partition.

3. The memory device of claim 1, wherein a first write operation to transfer data from the first partition to the second partition is faster than a second write operation to transfer data from the first partition to the third partition.

4. The memory device of claim 1, wherein data of the operating system accessed infrequently by a host processor is written from the first partition to the third partition.

5. The memory device of claim 1, wherein the first partition of memory is a static partition of memory.

6. The memory device of claim 1, wherein the first partition of memory is a dynamic partition of memory.

7. The memory device of claim 1, wherein the first partition of memory is a mixed static and dynamic partition of memory.

8. The memory device of claim 1, wherein the second partition of memory is a static partition of memory.

9. The memory device of claim 1, wherein a first range of logical block addressing range of size of the memory device substantially equivalent to an OS application size is mapped to the second partition of the memory.

10. A method comprising:
storing data associated with an operating system of an information handling system in a first memory partition of a memory device of the information handling system, the memory device including second, and third memory partitions; and
during execution of the operating system:
writing data frequently accessed by a host processor of the information handling system from the first memory partition to the second memory partition, wherein the first memory partition includes single-level cells and the second memory partition includes triple-level cells; and
writing data infrequently accessed by the host processor from the first memory partition to the third memory partition, wherein the third memory partition includes quad-level cells.

11. The method of claim 10, further comprising writing data in the second memory partition infrequently accessed by the host processor from the second memory partition to the fourth partition.

12. The method of claim 10, wherein the writing of the data from the first partition to the second partition is faster than the writing of the data from the first partition to the fourth partition.

13. The method of claim 10, wherein the first partition of memory is a static partition of memory, a dynamic partition of memory, or a mixed static and dynamic partition of memory.

14. The method of claim 10, wherein the second partition of memory is a static partition of memory.

15. The method of claim 10, wherein the third memory partition is a main storage partition of the memory device.

16. An information handling system comprising:
a host processor; and
a memory device to communicate with the host processor, the memory device including:
a first memory partition including single-level cells, wherein the first partition is a static partition of memory, a dynamic partition of memory, or a mixed static and dynamic partition of memory;
a second memory partition including triple-level cells, wherein the second partition is a static partition of memory; and
a third memory partition including quad-level cells.

17. The information handling system of claim 16, wherein data of an operating system frequently accessed by a host processor of the information handling system is written from the first memory partition to the second memory partition.

18. The information handling system of claim 16, wherein a first write operation to transfer data from the first partition to the second partition is faster than a second write operation to transfer data from the first partition to the fourth partition.

19. The information handling system of claim 16, wherein data of an operating system accessed infrequently by a host processor is written from the first partition to the fourth partition.

20. The information handling system of claim 16, wherein a size of a first logical block addressing range is substantially equivalent to the OS application size is mapped to the second partition of the memory.
